(19) United States
(12) Patent Application Publication
(10) Pub. No.: US 2004/0200121 A1
(43) Pub. Date: Oct. 14, 2004

(54) Lighted downrigger counter

(76) Inventor: Octave E. Lord, East Tawas, MI (US)

Correspondence Address: IRVING M. WEINER, WEINER & BURT P.C., 635 N. US-23, P.O. BOX 186, HARRISVILLE, MI, 48740, US

(21) Appl. No.: 10/800,886

(22) Filed: Mar. 15, 2004

Related U.S. Application Data
(60) Provisional application No. 60/456,152, filed on Mar. 20, 2003.

(51) Int. Cl. A01K 75/02

(52) U.S. Cl. 43/17.5

(57) ABSTRACT

A downrigger counter device which makes setting the downrigger equipment in the dark easier for a fisherperson. The downrigger device is provided with a source of light which is transmitted to the downrigger counter by way of fiberoptics.

The present patent application is based on and claims priority from U.S. Provisional Patent Application Serial No. 60/456,152 filed Mar. 20, 2003.

The present invention relates generally to a lighted downrigger counter device.

In particular, the present invention relates to a device which makes setting the downrigger equipment in the dark easier for the fisherperson.

### BACKGROUND OF THE INVENTION

The current technology does not provide any convenient way to light the numbers on the counters of all downriggers used for fishing. Consequently, people who are fishing are compelled to hold flashlights or other lights while attempting to set up in the dark to fish for salmon, walleye, steelhead and all other large fish.

The prior, but necessarily relevant, art is exemplified by the following U.S. patents.

U.S. Pat. No. 3,352,017 issued in 1967 to Newberg entitled “WATER DEPTH INDICATING DEVICE” discloses a depth indicator for fishing boats which can be operated with one hand and easily read by the fisherman. The size of the numerical indicia 44 and 46 is preferably sufficiently large so that it may be visually observed and read from distances to 10 feet or more.

U.S. Pat. No. 3,359,801 issued in 1967 to Rasmussen entitled “BATHYTHERMOGRAPH SYSTEM” discloses a device wherein a sheave is rotated by the paying put of a cable attached to a diving weight. As the sheave rotates, a cam cyclically actuates a switch and momentarily breaks a ground connection to an R.F. oscillator. The number of interruptions indicates the length of cable paid out.

U.S. Pat. No. 3,477,132 issued in 1969 to Laurien entitled “DEPTH MEASURING DEVICE” discloses a device which may include a resettable automatic counter having numbered discs observed through a window.

U.S. Pat. No. 3,478,462 issued in 1969 to Herbst et al. entitled “APPARATUS FOR ASCERTAINING LOAD CONDITIONS IN A DRAGNET” discloses an apparatus for sensing the presence of fish at a predetermined position in a fishing net. An output signal is produced by an oscillator and is communicated to a signal lamp 34 which is turned on when the corresponding net section is filled with fish.

It is a desideratum of the present invention to avoid the animadversions of the downrigger counter equipment presently available on the market, and to provide a lighted downrigger counter device which makes setting the downrigger equipment in the dark easier for the fisherperson.

### SUMMARY OF THE INVENTION

The present invention provides a downrigger counter device, comprising a downrigger board assembly; at least one downrigger counter mounted on said downrigger board assembly; and lighting means operably connected with said downrigger board assembly and said at least one downrigger counter for supplying light to numbers on said downrigger counter to aid a user of said downrigger counter device to set up equipment in dark or limited light conditions.

A primary object of the present invention is to provide a novel and unique lighted downrigger counter device.

A further object of the present invention is to provide such a lighted downrigger counter device which makes setting downrigger equipment in the dark easier for the fisherperson.

Another object of the present invention is to provide such a lighted downrigger counter device which utilizes fiberoptics.

Yet a further object of the present invention is to provide such a novel and unique lighted downrigger counter device wherein the electrical power therefor is hooked to the stern light power source of a boat, so that when the lights for the boat are turned on, the downrigger counters will light up.

Another object of the present invention is to provide such a lighted downrigger counter device having a downrigger board provided with a small light assembly which is operably connected to fiberoptic connections which run to the counters of the downrigger equipment.

Other objects and many of the attendant advantages of the present invention will become readily apparent to those skilled in this particular area of technology and to others by reference to the following detailed description and drawings.

### BRIEF DESCRIPTION OF THE DRAWINGS

FIG. 1 illustrates in schematic form an elevational view in accordance with a preferred embodiment of the present invention.

FIG. 2 depicts a side elevational view of the FIG. 1 embodiment.

### DETAILED DESCRIPTION OF THE INVENTION

Before setting forth a detailed description of the invention, it would perhaps be helpful to set forth some background concerning fishing with downriggers.

Trolling is the most effective way to catch many species of fish. A moving bait or lure in the water trolled at the depth where fish are present is the best way to ensure a hook-up.

The use of modern downrigger technology further improves trolling results. A downrigger is a spool of stainless steel wire which is usually mounted on a boat. A heavy weight is hung on the end of the braided downrigger wire. A downrigger release is hooked to the wire, and the fishing line is hooked into the release.

The downrigger can then be lowered to precisely the fish depth. When a fish hits, the line is released and the fisherperson fights the fish on the rod and reel free of heavy lines and weights.

Better downriggers are equipped with counters so that the fisherperson will know exactly how deep the line is. A fish finder and a downrigger are a very effective combination. The fish finder shows the user where the fish are, and the downrigger takes the user exactly to the fish.

When the fisherperson attempts to set up his or her equipment in the dark or limited light conditions, it becomes necessary to hold a flashlight or some other light while setting up for salmon, walleye, steelhead, and/or other large fish. The present invention avoids remedies this problem.

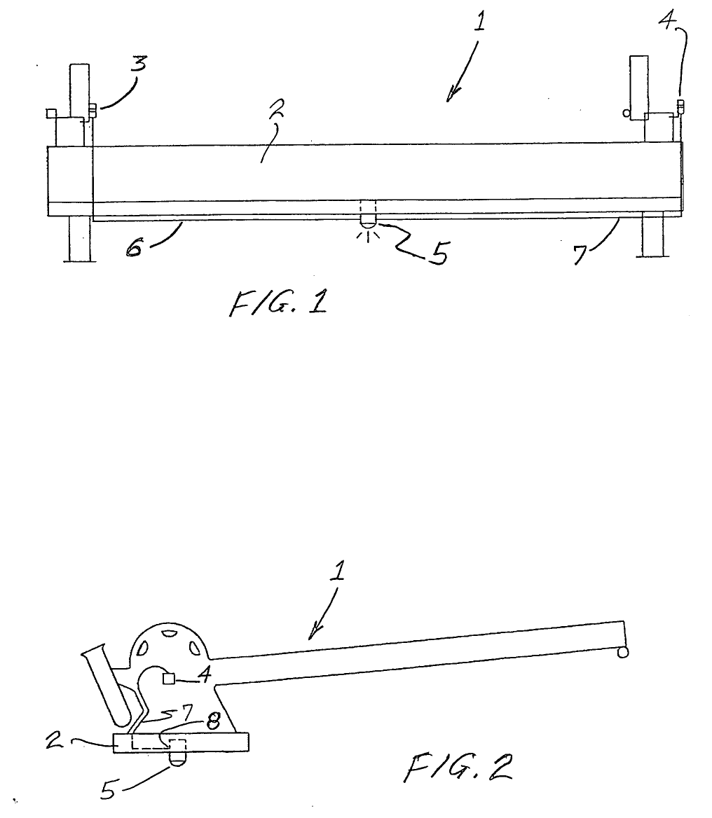

Referring to FIGS. 1 and 2, there is shown a lighted downrigger counter device 1 in accordance with a preferred embodiment of the present invention.

The lighted downrigger counter device 1 includes a downrigger board 2, one or more downrigger counters 3 and 4, a small light assembly 5, and one or more fiberoptic connections 6 and 7.

Preferably, but not necessarily, the small light assembly 5 obtains its electrical power from the stern light of the boat.

In such an arrangement when the lights for the boat are turned on, the downrigger counters 3 and 4 will light up.

Preferably, but not necessarily, a 0.118 inch hole 8 is drilled in the light assembly 5. Such hole 8 is used for connecting the respective fiberoptic connections 6 and 7 to light up the downrigger counters 3 and 4, respectively.

Although the present invention has been described hereinabove with reference to a specific embodiment thereof, it is not intended that the invention should be limited only to such embodiment.

While there has been shown, described and pointed out hereinabove the fundamental novel features of the present invention supplied in the preferred embodiment, it should be understood that various omissions, substitutions, changes in form, and details may be made by those skilled in the art without departing from the spirit of the invention.

1. A downrigger counter device, comprising:
a downrigger board assembly;
at least one downrigger counter mounted on said downrigger board assembly; and
lighting means operably connected with said downrigger board assembly and said at least one downrigger counter for supplying light to numbers on said downrigger counter to aid a user of said downrigger counter device to set up equipment in dark or limited light conditions.

2. A downrigger counter device according to claim 1, wherein:
said lighting means includes a light assembly connected to said downrigger board assembly.

3. A downrigger counter device according to claim 1, wherein:
said lighting means includes a light assembly and a fiberoptic connection between said light assembly and said downrigger counter.

4. A downrigger counter device according to claim 2, wherein:
there is provided a fiberoptic connection between said light assembly and said downrigger counter.

5. A downrigger counter device according to claim 1, wherein:
there is provided a downrigger counter at each end of said downrigger board assembly.

6. A downrigger counter device according to claim 2, wherein:
there is provided a downrigger counter at each end of said downrigger board assembly.

7. A downrigger counter device according to claim 3, wherein:
there is provided a downrigger counter at each end of said downrigger board assembly.

8. A downrigger counter device according to claim 4, wherein:
there is provided a downrigger counter at each end of said downrigger board assembly.

9. A downrigger counter device according to claim 6, wherein:
said lighting means includes a first fiberoptic connection extending from said light assembly to a first one of said downrigger counters, and a second fiberoptic connection extending from said light assembly to a second one of said downrigger counters.

10. A downrigger counter device according to claim 7, wherein:
said lighting means includes a first fiber optic connection extending from said light assembly to a first one of said downrigger counters, and a second fiber optic connection extending from said light assembly to a second one of said downrigger counters.

11. A downrigger counter device according to claim 8, wherein:
said lighting means includes a first fiberoptic connection extending from said light assembly to a first one of said downrigger counters, and a second fiberoptic connection extending from said light assembly to a second one of said downrigger counters.

12. A downrigger counter device according to claim 3, wherein:
said light assembly is provided with at least one aperture therein for connecting said fiberoptic connection to light up an associated downrigger counter.

13. A downrigger counter device according to claim 4, wherein:
said light assembly is provided with at least one aperture therein for connecting said fiberoptic connection to light up an associated downrigger counter.

14. A downrigger counter device according to claim 5, wherein:
said light assembly is provided with at least one aperture therein for connecting said fiberoptic connection to light up an associated downrigger counter.

15. A downrigger counter device according to claim 6, wherein:
said light assembly is provided with at least one aperture therein for connecting said fiberoptic connection to light up an associated downrigger counter.

16. A downrigger counter device according to claim 7, wherein:
said light assembly is provided with at least one aperture therein for connecting said fiberoptic connection to light up an associated downrigger counter.

17. A downrigger counter device according to claim 8 wherein:
said light assembly is provided with at least one aperture therein for connecting said fiberoptic connection to light up an associated downrigger counter.

18. A downrigger counter device according to claim 9, wherein:
said light assembly is provided with at least one aperture therein for connecting said fiberoptic connection to light up an associated downrigger counter.

19. A downrigger counter device according to claim 10, wherein:
said light assembly is provided with at least one aperture therein for connecting said fiberoptic connection to light up an associated downrigger counter.

20. A downrigger counter device according to claim 11, wherein:
said light assembly is provided with at least one aperture therein for connecting said fiberoptic connection to light up an associated downrigger counter.
